(19) United States
(12) Patent Application Publication
(10) Pub. No.: US 2019/0177186 A1
(43) Pub. Date: Jun. 13, 2019

(54) PROCESS FOR THE ELECTROCHEMICAL PURIFICATION OF CHLORIDE-CONTAINING PROCESS SOLUTIONS

(71) Applicant: Covestro Deutschland AG, Leverkusen (DE)

(72) Inventors: Andreas BULAN, Langenfeld (DE); Rainer WEBER, Odenthal (DE); Thorben MUDDEMANN, Köln (DE)

(21) Appl. No.: 16/324,264

(22) PCT Filed: Aug. 8, 2017
(86) PCT No.: PCT/EP2017/070088

§ 371 Date: Feb. 8, 2019

(30) Foreign Application Priority Data
Aug. 10, 2016 (EP) 16183517.8

(51) Int. Cl. C02F 1/467; C02F 1/461; C25B 1/46; C25B 15/08

(52) U.S. Cl. CPC C02F 1/4672; C02F 1/46109; C25B 1/46; C02F 2101/36; C02F 2001/46147; C02F 2201/46115; C25B 15/08

(57) ABSTRACT

The invention relates to a method for the electrochemical purification of chloride-containing, aqueous process solutions, which are contaminated with organic chemical compounds, using a boron-doped diamond electrode at a pH value of at least 9.5.

The invention relates to a process for the electrochemical removal of organic compounds from chloride-containing aqueous process solutions, in which the oxidation of the organic impurities is carried out anodically without chlorine in the oxidation slate zero or greater than zero being produced.

The alkali metal chloride-containing process solutions formed in many chemical processes cannot be processed further or disposed of without purification because of the contamination with organic chemical compounds, hereinafter also referred to as organic impurities for short, still present in the solutions. This is firstly because of the possible danger posed to the environment by the impurities, and secondly because of the negative influence of the impurities on the subsequent processes for work-up or further utilization, e.g. use of a sodium chloride-containing solution in chloralkali electrolysis to recover chlorine and sodium hydroxide as basic production chemicals. Here, the organic impurities can result in an increase in the cell voltage (increased energy consumption) and damage to the ion-exchange membrane of the electrolysis cell.

In the preparation of polycarbonates, the phase interface process, also referred to as the two-phase interface process, has been established for many years. The process makes it possible to prepare thermoplastic polycarbonates for a number of fields of use, e.g. for data carriers (CD, DVD), for optical applications or for medical applications.

A good thermal stability and low yellowing have frequently been described as important quality features for the polycarbonate. Less attention has hitherto been paid to the quality of the process water obtained in the preparation of polycarbonates. The pollution of the process water with residues of organic impurities in particular, e.g. phenol residues, is important for any further treatment of the process water, e.g. by means of a water treatment plant or by ozonolysis in order to oxidize the organic impurities. There is a series of publications in which, however, predominantly methods for subsequent process water treatment are described, with the objective of reducing the pollution with phenolic components, see, for example: JP 08 245 780 A (Idemitsu); DE 19 510 063 A1 (Bayer); JP 03 292 340 A (Teijin); JP 03 292 341 A (Teijin); JP 02 147 628 A (Teijin).

However, in these known processes, a high residual content of bisphenols or phenols, hereinafter also referred to as residual phenol content, in the process water from these processes, which can pollute the environment and places a particular load on the water treatment works, makes complicated purification necessary.

Such a sodium chloride-containing process water is usually freed of organic solvents and organic impurities and then has to be disposed of.

However, it is also known that the prepurification of sodium chloride-containing wastewater can, according to EP 1 200 359 B1 (WO 2000/078682 A1) or U.S. Pat. No. 6,340,736, be carried out by ozonolysis and the water is then suitable for use in sodium chloride electrolysis. A disadvantage of ozonolysis is that this process is very energy-intensive and costly.

According to EP 541 114 A2, a sodium chloride-containing process water stream is evaporated to complete removal of the water and the remaining salt with the organic impurities is subjected to thermal treatment, as a result of which the organic constituents are decomposed. The use of infrared radiation is particularly preferred here. A disadvantage of the process is that the water has to be evaporated completely, so that the process cannot be carried out economically because of the high energy consumption.

According to WO 03/070639 A1, process water from polycarbonate production is purified by extraction with methylene chloride and then fed to a sodium chloride electrolysis.

Disadvantages of the known work-up processes are the technically complicated way of carrying out the process with a total of four stages, which means an increased outlay in terms of apparatus, the use of solvents which have to be worked up, which results in a further engineering outlay, and finally the high energy consumption for carrying out the work-up.

The purification processes known from the prior art have a number of disadvantages.

In processes known from the prior art, the purification of the alkali metal chloride-containing solution is in practices carried out by stripping of the solution by means of steam and subsequent treatment with activated carbon; the purification is very particularly preferably carried out, after bringing the alkali metal chloride-containing solution to a pH of less than or equal to 8, by stripping by means of steam and subsequent treatment with activated carbon. The processes known from the prior art for purifying contaminated alkali metal chloride-containing aqueous solutions by use of adsorbent material such as activated carbon have the disadvantage that the activated carbon has to be replaced and worked up at regular intervals. Furthermore, the content of organic impurities in the purified process water has to be monitored continuously, since the adsorbent materials have a limited uptake capacity, in order to make it possible to use the purified solution in subsequent conventional sodium chloride electrolysis, which incurs a further outlay.

Apart from the abovementioned methods for the treatment of process water, treatment with ozone is also known. The treatment of process water with ozone is at least as expensive as the abovementioned purification methods because ozone production is energy-intensive and costly since, apart from the ozonizer, the provision and use of oxygen and the ultimately decisive yield of ozone, an additional apparatus for after-treatment of the process water is necessary.

It is an object of the invention to remove organic chemical impurities from chloride ion-containing aqueous process solutions which can be carried out in a simpler way, e.g. without use of absorbents, for example activated carbon, or by other energy-consuming purification methods as described above. The work-up of the adsorbents or the production of ozone would then be dispensed with. In particular, it is an object of the invention to enable purification of solutions which have a total content of organic impurities (TOC) of up to 10 g/kg and above. Furthermore, the formation of, in particular, organic chlorinated compounds from any reaction of chlorine with the organic chemical impurities present in the solution should be avoided.

A simple and efficient alternative, by means of which the chloride-containing process solutions can be purified so that further utilization or processing of the alkali metal chloride-containing process water that can be carried out with minimal problems is made possible, has therefore been sought. The purified alkali metal chloride-containing process water should, for example, be used directly in Is chloralkali electrolysis. Further processing of the purified alkali metal chloride-containing process water can be the concentration of the alkali metal chloride-containing solutions by means of membrane processes which are known in principle, e.g. osmotic distillation, membrane distillation, nanofiltration, reverse osmosis, or thermal evaporation. A particular object of the invention is to provide a purification process for aqueous chloride-containing process solutions, which starts out from chloride-containing solutions having a fluctuating concentration of organic chemical impurities and large volume flows which vary over time and makes it possible to purify these continuously and efficiently. In particular, large volume flows are flows of more than 0.1 m³/h.

The object is achieved according to the invention by provision of a process for the electrochemical removal of organic compounds from chloride-containing aqueous process solutions, in which the oxidation of the organic impurities is carried out anodically in the presence of a boron-doped diamond electrode without chlorine in the oxidation state zero or greater than zero being produced.

The general use of boron-doped diamond electrodes in the electrochemical disinfection of water is known in principle.

Lacasa et al. describe a process for disinfecting salt-containing process water in which microbes are present. Here, both an increase in the chloride concentration and also an increase in the current density lead to increased chlorine formation. The pH of the electrolyte was 8-9 (see: E. Lacasa, E. Tsolaki, Z. Sbokou, M. Rodrigo, D. Mantazavinos and E. Diamadopoulos, “Electrochemical disinfection of simulated ballast water on conductive diamond electrodes” Chem. Eng. Journal, vol. 223, pp. 516-523, 2013). The authors prefer the active evolution of chlorine in disinfection by means of a boron-doped diamond electrode in order to increase the disinfection effect.

Degaki et al. (A. H. Degaki, G. F. Pereira and R. C. Rocha-Filho, “Effect of Specific Active Chlorine Species,” Electrocatalysis, vol. 5, pp. 8-15, 201) describe the influence of sodium chloride (NaCl) in aqueous solution on the degradation of organic compounds when using boron-doped diamond electrodes and were able to find a significant acceleration of degradation as a result of addition of small amounts of NaCl and the formation of active chlorine.

According to the prior art, the formation of chlorine or hypochlorite in electrochemical purification by means of boron-doped diamond electrodes (BDD) is deliberately utilized for purification, since the purification effect in respect of the disinfection aspect is improved thereby. Here, chlorine or chlorine in the oxidation state greater than zero is produced at BDD electrodes. The process is also employed for removing cyanide from wastewater, with small amounts of chloride deliberately being added to the process water. This chloride is oxidized to hypochlorite at the BDD electrode and that then reacts with the cyanide (Perrot et al., Diamond and Related. Materials 8 (1999), 820-823), Elektrochemical Behavior of Synthetic Diamond Thin Film Electrodes).

In the presence of chlorine, which is formed in the known disinfection of wastewater by means of BDD electrodes, some amounts of chlorinated organic compounds, some of which are quite toxic, are unfortunately formed. In addition, residues of chlorinated organic compounds in the alkali metal chloride-containing aqueous solutions are fatal for the work-up of prepurified alkali metal chloride-containing aqueous solutions in order to recover chlorine and sodium hydroxide, for example by means of a conventional alkali metal chloride membrane electrolysis, since these residues can damage the ion-exchange membrane which is normally used in membrane electrolysis. Furthermore, the ion-exchange resins used for removing calcium or magnesium ions can also be damaged.

Further chlorination of impurities by the chlorine gas formed at the anode can form gaseous short-chain chlorinated compounds which are conveyed together with the chlorine from the chloralkali electrolysis cell and thus impair the quality of the chlorine for subsequent processes or lead to malfunctions in chlorine drying or chlorine compression.

There is no indication in the prior art that organic impurities can be removed from an alkali metal chloride-containing solution using a boron-doped diamond electrode, hereinafter referred to as BDD, without chlorine in the oxidation state zero or greater than zero being produced in the process.

The chlorine evolution which usually occurs in the electrochemical treatment of aqueous process solutions containing chloride and organic impurities according to the prior art leads to undesired chlorination of the organic impurities and thus not to the desired purification effect, since chlorinated organic impurities are inpart toxic and sometimes more difficult to remove than the nonchlorinated impurities and since chlorinated organic impurities cannot be degraded, can only be insufficiently degraded or are difficult to degrade in biological water treatment plants. In addition, chlorinated organic impurities make handling of the process water more difficult because of the toxicity of these compounds.

It has surprisingly been found that the formation of chlorine in the oxidation state zero or greater than zero is avoided when the pH of the alkali metal chloride-containing process solution is at least pH 9.5. The potential of the BDD anode here is more than 1.36 V. measured relative to the reversible hydrogen electrode (RHE). According to the prior art, chlorine in the oxidation state zero or greater than zero inevitably has to be produced from an alkali metal chloride-containing solution at an anode potential of more than 1.36 V. It has now been found that even at an anode potential of 2.8 V, no chlorine in the oxidation state zero or greater than zero is evolved in the new process. The process is consequently operated, in particular, so that no chlorine in the oxidation state zero or greater than zero is evolved in the electrochemical purification. This means that the total content of chlorine in the oxidation state zero or greater than zero in the alkali metal chloride-containing solution is not more than 300 mg/l, preferably not more than 100 mg/l, particularly preferably not more than 50 mg/l. As described above, this avoids the formation of undesirable chlorinated organic compounds which can damage a subsequent electrolysis apparatus. It is presumed that OH radicals, which degrade the organic impurities, are formed instead of chlorine gas when the process of the invention is employed.

The invention provides a process for the electrochemical purification of chloride-containing aqueous process solutions contaminated with organic chemical compounds using a boron-doped diamond electrode, characterized in that the purification using a boron-doped diamond electrode is carried out at a potential of more than 1.4 V measured against the reversible hydrogen electrode (RHE) and a pH of the process solution of at least 9.5, in particular at least pH 10, particularly preferably at least pH 11, in the anode zone of an electrolysis cell to a prescribed total content of organic chemical compounds (TOC).

The content of organic impurities can be decreased considerably by means of the process of the invention.

A preferred process is therefore characterized in that the purification is carried out to a total content of organic chemical compounds (TOC) of not more than 500 mg/kg, preferably not more than 100 mg/kg, in particular preferably not more than 20 mg/kg, particularly preferably not more than 10 mg/kg.

The concentration of chloride ions in the alkali metal chloride-containing process solution is, in a preferred embodiment of the invention, up to 20% by weight, preferably up to 15% by weight, at the beginning of the purification.

To carry out the process of the invention, it is possible to use commercial boron-doped diamond electrodes which are connected as anode. During operation as anode, the BDD anode presumably produces free OH radicals.

Diamond electrodes which are in principle particularly suitable for the novel process are characterized in that an electrically conductive diamond layer, which may be boron-doped, is applied to a suitable support material. The most frequently employed process for producing such electrodes is the “hot filament chemical vapor deposition” technique (HFCVD) in order to produce active and stable BDD electrodes. Under reduced pressure (order of 10 mbar) and higher local temperature (>2000° C.), which is generated by means of hot wires, a carbon source (e.g. methane) and hydrogen are used. Under these process conditions, free hydrogen radicals formed make it possible to form free methyl radicals which are ultimately deposited as diamond on a support material (FIG. 2.13). [M. Rüffer, “Diamond electrodes—properties, fabrication, applications,” lecture at ACHEMA 2015, Frankfurt am Main, 2015.] Electrochemical use requires conductive electrodes, for which reason the diamond layer is doped with boron in the production process. To effect boron doping, recourse is made to low concentrations of diboranes, trimethylborane, boron trioxide or borates. [L. Pan and D. Kanja, Diamond: Electronic Properties and Applications, Kluwer Academic Publishers: Boston, 1995.] It is also customary to pass an additional hydrogen gas stream through a methanol/boron trioxide solution (having a defined C/B ratio). [E. Brillas and C. A. Martinez-Huitle, Synthetic Diamond Films: Preparation, Electrochemistry, Characterization and Applications, John Wiley & Sons, 2001].

The process of the invention can preferably be carried out using BDD electrodes in which the boron-doped diamond layer has been applied to various base materials. Thus, it is possible to use, independently of one another, titanium, silicon or niobium as support material. A preferred support material is niobium. Other support materials to which the diamond layer adheres and forms a dense layer can in principle also be used.

The electrically conductive support for producing the BDD can in principle be a gauze, nonwoven, foam, woven mesh, braid or expanded metal. Preference is given to using a support in the form of an expanded metal. The support can have one or more layers. A multilayer support can be made up of two or more superposed gauzes, nonwovens, foams, woven meshes, braids or expanded metals, The gauzes, nonwovens, foams, woven meshes, braids or expanded metals can here be different. They can, for example, have different thicknesses or different porosities or have a different mesh size. Two or more gauzes, nonwovens, foams, woven meshes, braids or expanded metals can, for example, be joined to one another by sintering or welding.

In a preferred embodiment, a boron-doped diamond electrode which is built up on a support based on at least one material selected from the group consisting of: tantalum, silicon and niobium, preferably niobium, is used, The diamond layer adheres best to these materials.

To increase the chemical resistance, in particular toward alkali, particular preference is given to using a boron-doped diamond electrode which has a multiple coating of finely divided diamond.

The multiple coating of the boron-doped diamond electrode with diamond particularly preferably has a minimum layer thickness of 10 μm. This avoids corrosion of the support material under the diamond layer on contact with alkali.

The new purification process can be carried out in commercial electrolysis cells having the abovementioned BDD as anode, with preference being given to using electrolysis cells through which good flow occurs, in particular cells having anode halves with turbulent flow.

In principle, an electrolysis cell which is particularly suitable for the novel purification process consists of two electrodes, namely an anode and a cathode, an electrode space surrounding the electrodes and at least one electrolyte. Here, it is possible to use a separator between anode and cathode so as to separate the electrode spaces of the electrolysis cell into an anode space and a cathode space. An ion-exchange membrane or a diaphragm can be used as separator. A boron-doped diamond electrode (BDD) is used as anode, and as cathode it is likewise possible to use, for example, a BDD of the same type or any other cathode which evolves hydrogen.

In a particular embodiment, an oxygen depolarized gas diffusion electrode at which no hydrogen evolution takes place can also be used as cathode. If, for example, an ion-exchange membrane is used in the electrolytic cell for the purification, the electrolyte in the anode space can be different from that in the cathode space. Thus, the alkali metal chloride-containing process solution to be purified can be supplied to the anode and another electrolyte, e.g. an alkali metal hydroxide solution such as sodium hydroxide solution, can be supplied to the cathode. The concentration of the catholyte can, as a function of the system, be matched to and optimized in respect of materials, temperatures and required conductivity. If an oxygen depolarized cathode is used on the cathode side in a divided cell and sodium hydroxide is used in the electrolyte on the cathode side, the sodium hydroxide is concentrated on the cathode side.

If an oxygen depolarized cathode is used, this generates hydroxide ions from water and oxygen. An advantage of the oxygen depolarized cathode is the cell voltage which is lower by up to 1 V. When an oxygen depolarized cathode as described, for example, in EP1728896A is used, the electrolyte can be a sodium hydroxide or potassium hydroxide solution having a concentration of from 4 to 32% by weight. Air or pure oxygen can be used for operating the oxygen depolarized cathode.

As an alternative, an electrode for hydrogen evolution, e.g. consisting of steel or nickel, can also be used as cathode (as described, for example, in DE 102007003554). Other types of cathodes as are used in chloralkali electrolysis or in the electrolysis of water are likewise conceivable.

The alkali metal chloride in the process water of the novel purification process can, for example, be present as sodium chloride or potassium chloride. Sodium chloride, which is converted into sodium hydroxide and chlorine in a downstream chloralkali electrolysis, has the greater economic importance. However, process waters having other chlorides are likewise conceivable and can in principle be treated by the novel process.

The process of the invention is preferably carried out in such a way that the pH of the chloride-containing aqueous solution to be purified is at least 9.5, in particular at least pH 10, particularly preferably at least pH 11, and the pH also during the electrolysis does not attain or go below this pH value. The formation of chlorine and any formation of chlorinated organic compounds is reliably prevented by means of this measure.

The chloride-containing aqueous solution to be purified can, in a preferred process, be passed one or more times through the anode side of the electrolytic cell, in particular until a desired residual TOC value has been reached.

The total content of organic chemical impurities (usually referred to as TOC) in the aqueous solution to be purified can be more than 10 000 ppm (measured in mg/kg) in the novel electrolytic purification process by means of BDD.

Impurities typical of the production of polymer products, for example hydroquinone, resorcinol, dihydroxybiphenyl, bis(hydroxyphenyl)alkanes, bis(hydroxyphenyl)cycloalkanes, bis(hydroxy-phenyl) sulfides, bis(hydroxyphenyl) ethers, bis(hydroxyphenyl) ketones, bis(hydroxyphenyl) sulfones, bis(hydroxyphenyl) sulfoxides, (bis(hydroxyphenyl)diisopropylhenzenes and also alkylated, ring-alkylated and ring-halogenated compounds thereof, oligocarbonates, tertiary amines in particular triethylamine, tributylamine, trioctylamine, N-ethylpiperidine, N-methylpiperidine, N-i/n-propylpiperidine, quaternary ammonium salts such as tetrabutylammonium/tributyl-benzylammonium/tetraethylammonium hydroxide/chloride/bromide/hydrogensulfate/tetrafluoro-borate and also the phosphonium compounds corresponding to the ammonium compounds or other organic chemical compounds such as formates, aromatics, anilines, phenols, alkyl compounds such as carboxylic acids, esters, alcohols, aldehydes, can be present in the process water to be purified and are degraded by means of the novel electrolytic purification process. The concentration of each of these impurities here can be more than 1000 mg/kg.

In a preferred process, the process water to be purified contains organic solvents, in particular one or more solvents from the group consisting of: aliphatic hydrocarbons, in particular halogenated aliphatic hydrocarbons, particularly preferably dichloromethane, trichloroethylene, 1,1,1-trichloroethane, 1,1,2-trichloroethane and mixtures thereof, or aromatic hydrocarbons, in particular benzene, toluene, m/p/o-xylene, or aromatic ethers such as anisole, halogenated aromatic hydrocarbons, in particular monochlorobenzene and dichlorobenzene, as organic chemical impurity. Solvent residues are typical contaminants from the production of polymers, in particular of polycarbonates or polyurethanes.

The novel process is consequently employed, in a particularly preferred embodiment, in the continuous production of polycarbonate by reaction of bisphenols and phosgene in an inert solvent or solvent mixture in the presence of base(s) and catalyst(s), in which improved recirculation of sodium chloride from the sodium chloride-containing process water solutions obtained in the interface without complicated purification after setting of the pH to a pH of less than or equal to 8 and after treatment with activated carbon is made possible by the process solution being able, after purification by means of the novel electrochemical purification process, to be achieved directly to electrochemical oxidation of the sodium chloride present to chlorine, sodium hydroxide and optionally hydrogen, with the chlorine being able to be recirculated to production of the phosgene.

Such a specific process has become known from EP2096131A , which describes a process for producing polycarbonate by the phase interface process with processing of at least part of the alkali metal chloride-containing solution obtained in a downstream alkali metal chloride electrolysis. According to this prior art, the alkali metal chloride-containing solution is freed of solvent residues and optionally catalyst residues by, in particular, stripping of the solution with steam and treatment with adsorbents, in particular with activated carbon. In the treatment with adsorbents in particular, the alkali metal chloride-containing solution has a pH of less than or equal to 8. Use of the process of the invention enables this complicated form of purification to be dispensed with and the process solution to be purified directly by electrochemical means.

The novel electrochemical purification process can also be combined with the preparation of isocyanates which is known in principle. EP2096102A describes a process for preparing methylenedi(phenyl isocyanate), hereinafter referred to as MDI, by phosgenation of the corresponding polyamines of the diphenylmethane series. The MDI synthesis usually occurs in a two-stage process. Aniline is firstly condensed with formaldehyde to form a mixture of oligomeric and isomeric methylenedi(phenylamines) MDA and polymethylenepolyamines, known as crude MDA. This crude MDA is subsequently reacted with phosgene in a manner known per se in a second step to give a mixture of the corresponding oligomeric and isomeric methylenedi(phenyl isocyanates) and polymethylenepolyphenylene polyisocyanates, known as crude MDL The continuous, discontinuous or semicontinuous preparation of polyamines of the diphenylmethane series, hereinafter also referred to as MDA for short, has been described in numerous patents and publications (see, for example, H. J. Twitchett, Chem. Soc. Rev, 3(2), 209 (1974), M. V. Moore in: Kirk-Othmer Encycl. Chem. Technol., 3rd, Ed., New York, 2, 338-348 (1978). The preparation of to MDA by reaction of aniline and formaldehyde is usually carried out in the presence of acid catalysts. Hydrochloric acid is usually used as acid catalyst, with the acid catalyst being, according to the prior art, neutralized and thus consumed by addition of a base, typically aqueous sodium hydroxide, at the end of the process and before the final work-up steps, for example the removal of excess aniline by distillation. In general, the addition of the neutralizing agent is carried out in such a way that the resulting neutralization mixture can be separated into an organic phase containing the polyamines of the diphenylmethane series and excess aniline and an aqueous phase containing residues of organic constituents in addition to sodium chloride. The aqueous phase is generally disposed of as inorganically loaded process water after removal of the organic constituents. All these production processes can also be coupled with the novel electrochemical purification process and replace known complicated purification steps.

In a further preferred embodiment of the invention, a process solution containing, as organic chemical impurity, catalyst residues, in particular one or more compounds from the group consisting of: tertiary amines, in particular triethylamine, tributylamine, trioctylamine, N-ethylpiperidine, N-methylpiperidine, N-i/n-propylpiperidine; quaternary ammonium salts such as tetrabutylammonium/tributylbenzylammonium/tetraethylammonium hydroxide/chloride/bromide/-hydrogen sulfate/tetfluoroborate; and the phosphonium compounds corresponding to the ammonium compounds, is used as process solution.

The process solution from polymer production can in principle also comprise additional residues of monomers or low molecular weight polymers. Particular preference is therefore given to a variant of the novel purification process in which the process solution contains, as organic chemical impurity, monomers or low molecular weight polymers, in particular one or more compounds from the group consisting of: hydroquinone, resorcinol, dihydroxybiphenyl, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, (α,α′-bis(hydroxyphenyl)diisopropylbenzenes and the alkylated, ring-alkylated and ring-halogenated compounds derived therefrom, oligocarbonates.

The purification process can also serve to purify alkali metal chloride-containing process water from the production of other basic chemicals. For example, cresol-containing and alkali metal chloride-containing process waters are obtained in the preparation of cresols as intermediates for crop protection agents or pharmaceuticals and these can preferably be removed by means of the purification process.

As electrolysis cell which contains the BDD electrode, it is possible to use various forms of cell constructions as described above. Thus, divided or undivided cells can be employed. The distance between cathode and anode can be from 0.01 mm to 20 mm here. Cell material which is contacted by the process solution, e.g. cell half shells or seals, consist of, in particular, suitable resistant polymers, e.g. polytetrafluoroethylene (PTFE), polyvinylidene fluoride (PVDF), polypropylene or polyethylene or metals such as nickel or steel.

One possible embodiment of the electrolysis cell which can particularly preferably be used in the novel electrolytic purification process can have the following structure:

As anode, it is possible to use a BDD electrode in the form of a metal sheet, e.g. an electrode marketed under the name DIACHEM® by Condias or an expanded metal electrode from Diaccon (http://www.diaccon.de/de/produkte/elektroden.html) or an electrode marketed under the name NeoCoat® electrodes (http://www.neocoat.ch/en/products/electrodes/bdd-me). Flow of the process solution to be purified over a planar or expanded metal electrode is possible, as is flow through an expanded metal electrode.

As cathode, particular preference is given to using an oxygen depolarized cathode from Covestro, produced as described in EP1728896A.

Anode space and cathode space can, for example, be separated by an ion-exchange membrane; for example, a cation-exchange or anion-exchange membrane is suitable. As cation-exchange membrane, it is possible to use, for example, a membrane of the Chemours type N145 or a membrane of the Flemion type F133 from Asahi Glass.

Electrolysis cells having an installed membrane area of from 10 cm² to 40 000 cm² and more can be used on the production scale. The membrane area corresponds here to the area of the electrode used.

The electrodes and the membrane can particularly preferably be arranged in parallel. Frames and in-between frames necessary for fixing the electrode spacings and the membrane can, for example, consist of polypropylene and are matched to the respective electrolyte.

Seals used are very particularly preferably made of expanded polytetrafluoroethylene (ePTFE, e.g. from Gore; Gore GR).

In the case of a divided cell, it is possible to use, for example, a sodium hydroxide solution having a concentration of from 4 to 35% by weight as catholyte. The use of an alkali metal chloride solution as catholyte is likewise possible, with the concentration of alkali metal chloride preferably corresponding to that of the anolyte. The alkali metal chloride solution can here be the alkali metal chloride solution to be purified or, better, a solution which does not contain any organic impurities.

The anode-side volume flow of the chloride-containing solution to be purified is, based on a geometric electrode area of 100 cm², from 30 to 500 000 l/h , in particular in the case of flow to through BDD mesh electrodes.

If plate-type electrodes are used, the flow velocity over them is typically from 300 to 1400 m/s. A relatively high flow velocity over the electrodes or a relatively high volume flow is possible and necessary for the degradation of organics due to the increased turbulence of the process water to be purified.

When a divided cell is used, the catholyte volume flow will typically be from 2 to 5000 l/h based on an electrode area of 100 cm², corresponding to a linear velocity of from about 0.01 cm/s to 15 cm/s. In the case of larger electrode areas, the volume flow and the flow velocity over the electrodes resulting therefrom according to the cell design have to be adapted correspondingly.

To monitor the purification process of the invention, a measurement of the potential at the anode or at the cathode or at both electrodes can be carried out in a preferred embodiment of the invention. For example, a Luggin capillary is positioned here in front of the active side of the electrode so as to form an electrically conductive salt bridge to a reference electrode, e.g. a reversible hydrogen electrode, RHE.

If an oxygen depolarized cathode is used in a preferred embodiment of the novel purification process, an oxygen-containing gas is additionally required. The differential pressure between gas side and electrolyte side of the gas diffusion electrode which is necessary for satisfactory operation of the gas diffusion electrode can, for example, be set via the oxygen pressure. As an alternative, the electrolyte pressure can also be reduced. Depending on the gas diffusion electrode used, the pressure difference between electrolyte and gas side is in the range from −20 to +40 mbar. This prevents gas from getting from the gas space through the oxygen depolarized cathode into the electrolyte space or electrolyte getting from the electrolyte space into the gas space.

The treatment of the chloride-containing solution to be purified is, in particular, carried out at a current density of from 0.1 to 10 kA/m², preferably from at least 1 to 10 kA/m², with the potential of the BDD anode being >1.36 V measured relative to the reversible hydrogen electrode (RHE), preferably >2.5 V relative to the RHE. A very high current density improves the economics of the purification process on the industrial scale. The volume flow of the alkali metal chloride-containing process water can be limited by the cell geometry, i,e. the electrode spacing, the anode and cathode volumes, but in particular the anode volume, the electrode geometry, the size of the electrode and the pressure difference between anolyte inlet and outlet.

Depending on the electrode size and geometry, a single pass through the cells can be sufficient to achieve the desired degradation of organic impurities, but preference is given to multiple passes. As an alternative, the anode zones of a plurality of electrolysis cells can also be connected in series, so that the purification is preferably carried out in a number of separated anode zones connected in series.

The temperature at which the chloride-containing solution to be purified is subjected to the electrolysis is preferably the temperature of the chloride-containing process water. The temperature is particularly preferably ambient temperature.

Before commencement of the electrolytic purification, the pH of the electrolyte which contacts the anode, in particular, should be sufficiently high, so that this electrolyte has a pH (anolyte) of at least 9.5, in particular at least pH 10, particularly preferably at least pH 11, over the entire electrolysis time. Regulation of the pH, which in the case of the process water conveyed in a circuit is arranged in the circuit, preferably downstream of the cell, ensures that the pH during the process water treatment remains in the intended range of at least pH 9.5, in particular at least pH 10, particularly preferably at least pH 11. The setting of the pH is usually carried out by introduction of alkali metal hydroxide solution, in particular sodium hydroxide solution.

Despite the high chloride concentration and the thermodynamically sufficient potential for the production of chlorine, no chlorine in the oxidation stage greater than or equal to zero is produced in the process of the invention. The impurities can thus be carbonized, i.e. converted into, for example, carbon dioxide, without chlorinated products of the impurities being formed.

The novel purification process is applied in particular to NaCl-containing process water from the production of polymers, in particular a polymer from the group consisting of polycarbonate, polyurethanes and precursors thereof, in particular isocyanates, particularly preferably methylenedi(phenyl isocyanate) (MDI), tolylene diisocyanate (TDI), or from the production of dyes, crop protection agents, pharmaceutical compounds and precursors thereof.

The novel purification process can also be employed in the purification of process water from the production of epichlorohydrin, which is, in particular, an intermediate for the production of glycerol, epoxy resins, elastomers and adhesives.

The purified alkali metal chloride solution is, in particular, subjected to an electrolysis for reuse of chlorine and alkali metal hydroxide, in particular sodium hydroxide, as a material. The invention consequently also provides a combined purification process in which the purified process water is subsequently subjected to an alkali metal chloride electrolysis, in particular by the membrane process, to produce chlorine, alkali metal hydroxide, in particular sodium hydroxide, and optionally hydrogen.

In order to close operational materials circuits, it is particularly advantageous to reuse the materials obtained from a downstream alkali metal chloride electrolysis in preceding production processes.

The invention therefore also provides a combined purification process in which the materials chlorine and alkali metal hydroxide, in particular sodium hydroxide, and optionally hydrogen obtainable from the alkali metal chloride electrolysis located downstream of the electrolytic purification are recirculated, independently of one another, to the chemical production of polymers, dyes, crop protection agents, pharmaceutical compounds and precursors thereof.

### EXAMPLES (GENERAL DESCRIPTION)

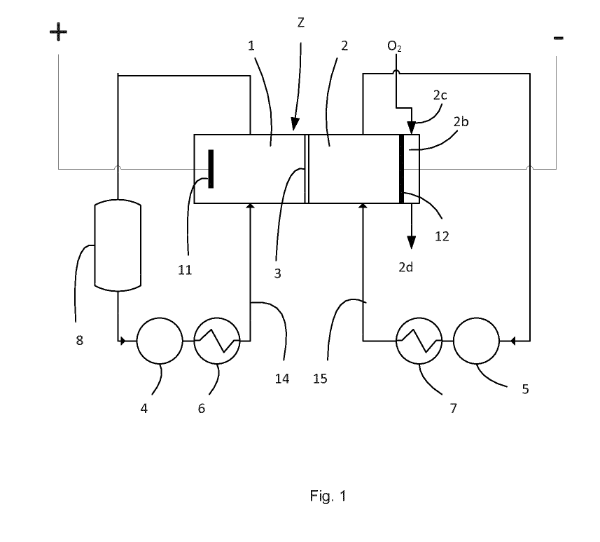

A cell Z divided by an ion-exchange membrane 3, as is shown schematically in FIG. 1, was used. A Diachem® diamond electrode from Condias (plate electrode) or an expanded metal electrode from DIACCON was used as an anode 11 in an anode space 1. The electrode here is in each case a diamond electrode on the support material niobium. The active area, measured at the ion-exchange membrane area of the electrolysis cell, was 100 cm². The electrode spacing was 12 mm, resulting from an 8 mm space in between anode 11 and membrane 3 and a 4 mm spacing between membrane 3 and cathode 12, A Flemion F-133 membrane from Asahi Glass was used as ion-exchange membrane 3. The laboratory cell was pressed together by means of six threaded rods and nuts (M12) tightened with a defined moment of 15 Nm. The electrolytes 14 and 15 were in each case circulated. An electrolyte pump 4 was in each case used for the anolyte 14 and a pump 5 was used for the catholyte 15. The anolyte 14 was pumped in the circuit at a volume flow of 76.8 l/h and the catholyte 15 was pumped in the circuit at a volume flow of 15.0 l/h. Before each experiment, both circuits were flushed with DI water (DI=deionized) for about one hour; the water was changed three times during the time. After introduction of the electrolytes 14, 15, these were pumped at the abovementioned volume flow through the heat exchangers 6, 7 and heated to a temperature of 60° C. The temperature was measured by means of the temperature sensors (Pt 100) in the respective circuit. Depending on the way in which the process solution to be purified is to be treated, a storage vessel 8 for stocking the process solution to be purified can be additionally installed in the circuit.

An oxygen depolarized cathode (ODC) 12 was used as cathode. The cathode space 2 is separated impermeably from the gas space (2b) by the oxygen depolarized cathode 12. To start up the electrolysis, pure oxygen or an oxygen-containing gas is introduced via an inlet 2c into the gas space 2b. Excess oxygen/oxygen-containing gas goes out from the gas space 2b again via the outlet 2d. The gas stream leaving the outlet 2d from the gas space 2b could be backed up by banking-up or by means of immersion into a liquid and the pressure in the gas chamber 2b could thus be increased. The oxygen pressure in the gas space 2b preferably more than 20 mbar and can, depending on the cell design, be increased up to 60 mbar. Possible condensate formation caused in the gas space 2b, e.g. by passage of catholyte through the ODC 12 is discharged together with excess gas via 2d from the gas space 2b. On reaching the desired electrolyte temperature, the rectifier (not shown) is switched on and the current is increased in a ramp up to the desired operating current. The rectifiers are controlled by a measuring and regulating system from Delphin. At the beginning of the experiment, samples were taken from the anolyte circuit and the catholyte circuit in order to determine the initial pH of the solutions by means of a pH meter and for monitoring by means of acid-base titration. In addition, samples were taken from the anolyte circuit at defined time intervals during the experiment in order to determine the decrease in TOC over time. The cell voltage and also the anode and cathode potentials were continually measured and monitored during the experiment.

In order to set the pH of the electrolytes and observe the course during the experiment, the pH was determined by means of a pH measuring instrument from Mettler Toledo (model FiveEasy) and monitored by means of an acid-base titration.

The TOC content of the samples was determined by means of a TOC instrument from Elementar (model vario TOC cube). The sample was here diluted with DI water by a factor 5 and brought to a pH of 1 by means of concentrated hydrochloric acid (32% by weight). The chlorine analysis used for evaluating the experiments is described in detail below.

Furthermore, the anolyte was examined for the presence of chlorine in the oxidation state zero or greater than zero and also in respect of the chloride concentration. For analysis of the chloride concentration, the Mohr chloride determination was employed. Firstly, 1 ml of the solution is taken at room temperature (Eppendorf pipette), diluted with 100 ml of distilled water and a spatula tip of sodium hydrogencarbonate (NaHCO₃) (pH buffer) is subsequently added. The sample is subsequently acidified by means of 5-10 drops of 10% strength nitric acid, and 5 ml of potassium chromate solution are added. The solution is then titrated against a 0.1 M silver nitrate solution (AgNO₃) until a brown coloration persists. As a result of the silver nitrate solution added during the titration, white silver chloride precipitates at the equivalence point. The persistent brown coloration arises from the equivalence point onward by formation of sparingly soluble silver chromate. The concentration of sodium chloride is thus calculated from the consumption of silver nitrate.

The analysis to determine whether chlorine in the oxidation state zero or greater than zero is present is carried out by analysis of the compounds sodium hypochlorite or hypochlorous acid and chlorate. The analysis of sodium hypochlorite/hypochlorous acid and chlorate is carried out by total chlorine determination in bleaching liqor. 1 ml of the sample solution was firstly diluted with distilled water to 300 ml and provided with a spatula tip of NaHCO₃. The titration was subsequently carried out with arsenous acid (0.05 M) as spot sample on potassium iodide starch paper. In the presence of sodium hypochlorite/hypochlorous acid, chlorine and chlorate, the potassium iodide starch paper becomes violet, and the titration was carried out until the spot sample on the starch paper no longer displayed a coloration.

The proportion of the total chlorine which was present in the form of chlorate was determined as follows: the detection of chlorate was carried out directly after the total chlorine determination. To determine the chlorate concentration of the solution, it is firstly necessary to determine a blank, and subsequently determine the sample value. The blank characterizes the amount of chlorate in the solution before the sample is added. 10 ml of the sulfuric acid ammonium iron(II) sulfate solution (for the blank determination without sample) was firstly added to the 1 ml sample and the mixture was diluted with distilled water. The reagent was brought to boiling and boiled for 10 minutes. After cooling, a titration with potassium permanganate solution (KMnO₄, 0.02 M) was carried out to the first persistent pink coloration both for the blank determination and also the determination of chlorate. In the detection of chlorate, the chlorate firstly reacts with the Fe²⁺ions of the acidic solution, and the excess of Fe²⁺ions is subsequently oxidized by means of potassium permanganate solution (KMnO₄). The concentration of chlorate is calculated from the consumption of potassium permanganate solution by sample and blank.

The cell construction described serves merely to illustrate the process of the invention. The process to water treatment can be carried out in various cell designs with and without use of a gas diffusion electrode.

### Example 1—According to the Invention—Formate Degradation—Illustrative Imitation Process Water From Methylenedi(Phenylamine) (MDA) Production

The process water to be treated was circulated through a laboratory electrolysis cell equipped with a Condias Diachern® electrode as described above, a Covestro oxygen depolarized cathode and a cation-exchange membrane of the Flemion F133 type at a current of 4 kA/m² and correspondingly an average voltage of 4 V. The anolyte consisted of a sodium chloride-containing process solution containing 10% by weight of sodium chloride and having a pH of 14.4. The content of sodium formate impurity was, measured as TOC, 24.48 mg/kg. A 1 molar sodium hydroxide solution was used as catholyte.

During the one hour during which the experiment was carried out, the anode potential was a constant 3.0 V vs, RHE, and the average cathode potential was 0.6 V vs. RHE. Furthermore, the degradation of organics (TOC) was measured over the experiment and the anolyte was examined to determine its total chlorine content (sodium hypochlorite, hypochlorous acid and chlorate) as described above.

The TOC content was 24.48 mg/kg at the beginning and could be completely mineralized at 20 Ah/l, so that the TOC at the end of the experiment was <1 mg/kg. The formation of chlorine in the oxidation state zero or greater than zero at the anode could not be detected during the entire process procedure.

### Example 2—According to the Invention—Phenol Degradation

A 10% strength by weight NaCl-containing solution was admixed with phenol so that a TOC of 30.55 mg/kg was measured. The pH of the solution was 14.31. The solution was treated in an electrolysis cell as described in example 1 . The current density was maintained at 3 kA/m². After the application of 30 Ah/l, the TOC content was only 9 mg/kg. The formation of chlorine in the oxidation state zero or greater than zero at the anode could not be detected here either.

### Example 3—According to the Invention—Process Water from MDA Production Production

The experiment of example 1 was carried out using an NaCl-containing solution from production of MDA. The pH of the NaCl-containing solution was 14.46. The solution had an initial TOC value of 70 mg/kg and was treated at a current density of 6 kA/m². After 30 Ah/l, the TOC content was only 7 mg/kg.

Here too, purification of the process water could be carried out successfully, with no chlorine in the oxidation state zero or greater than zero being detected.

### Example 4—According to the Invention—Degradation of Catalyst from Polycarbonate—Ethylpiperidine

The experiment of example 1 was carried out using ethylpiperidine as example of a catalyst residue as organic impurity in 10% strength by weight sodium chloride solution at a pH of 14.38. The averagae cell voltage was about 4.3 V at a current density of 4 kA/m². The TOC content at the beginning of the electrolysis was 28 mg/kg. After introduction of a total of 30 AM, the TOC content was only 15 mg/kg. Formation of chlorine, hypochlorite or chlorate was not observed.

The anolyte was additionally examined titter the end of a Gerstel PDMS Twister analysis (absorption of polydimethylsiloxane and subsequent desorption with subsequent gas chromatography/mass spectrometry) and the organic trace materials present in the anolyte were revealed and identified. Chlorinated hydrocarbons could not be determined. This demonstrates that no chlorine formation occurs at the BDD anode in combination with the absent chlorine in the oxidation state zero and greater than zero.

### Example 5—Comparative Example Using Standard Coating of an Anode from Chloralkali Electrolysis (DSA Coating) Compared to a BDD Anode

The experiment of example 4 was carried out using a dimensionally stable anode (DSA) provided with a coating corresponding to chloralkali electrolysis. The coating was based on a mixture of iridium oxide and ruthenium oxide from Denora.

Even when samples were taken during the experiment, an odor of chlorine could be perceived. The consequent of anodic chlorine formation is the formation of chlorinated hydrocarbons, which could be confirmed by means of a Twister analysis of the anolyte after the end of the experiment.

### Example 6—BDD Coatings Comparative Example pH<9.5

The experiment described under example 3 was repeated, but the pH of the anolyte was set to pH 8. The experiment was carried out at a current density of 4 kA/m², and an average cell voltage of 4.5 V was established. After the end of the experiment, chlorinated hydrocarbons could likewise be found in the anolyte by means of a Twister analysis.

### Example 7—BDD Using Imitation Process Water

In a cell as described in example 1 but equipped with an expanded metal electrode from DIACCON, an NaCl-containing solution having the following composition was used as anolyte: 15 g/l of NaCl, 132 mg/kg of formate, 0.56 mg/kg of aniline, 11.6 mg/kg of MDA, 30 mg/kg of phenol. The pH of the solution was 13.4. The volume flow of the anolyte was 121 l/h. A 1 molar sodium hydroxide solution was used as catholyte and was pumped at a volume flow of 15 l/h around the circuit. The current was 1 kA/m², and the temperature was 60° C. The initial TOC was 78 mg/kg. After 30 minutes, the pH was 13.2 and the TOC content was only 18 mg/kg. 4 Ah/l of charge were introduced for the purification. The formation of chlorine in the oxidation state zero or is greater than zero at the anode could not be detected.

### Example 8—MDA Degradation

A 10% strength by weight NaCl-containing solution was admixed with 0.45 millimol of methylenedi(phenylamine) (MDA) and treated in an electrolysis cell as described in example 1. The pH was 14.4, and the current density was 5.5 kA/m². The amount of dissolved MDA, which corresponded to a measured TOC of 25 mg/kg, was completely mineralized electrochemically after only 10 AWL The TOC content of the treated solution was 0 mg/kg. The formation of chlorine in the oxidation state zero or greater than zero at the anode could not be detected.

### Example 9—pH 7—Influence of pH Value

In a cell as described in example 1 but equipped with an expanded metal electrode from DIACCON, an NaCl-containing solution having the following composition was used as anolyte: 15 g/l of NaCl, 132 mg/kg of formate, 0.56 mg/kg of aniline, 11.6 mg/kg of MDA, 30 mg/kg of phenol. The pH of the solution was 13.4. The volume flow of the anolyte was 121 l/h. A 1 molar sodium hydroxide solution was used as catholyte and was pumped around the circuit at a volume flow of 15 /h. The current was 1 kA/m², and the temperature was 60° C. The initial TOC was 78 mg/kg. After 20 minutes, the pH was 13.4 and the TOC content was 34 mg/kg. The formation of chlorine in the oxidation state zero or greater than zero at the anode could not be detected.

The pH was then decreased to pH 7. After introduction of only 4 Ah/l, 3.5 g/l of chlorine in the oxidation state zero or greater than zero were found. The TOC content was not reduced in this case.

### Example 10—Use of a Purified MDA Process Water in the Chloralkali Electrolysis Cell

Process water is purified as described in example 1 and brought by means of solid sodium chloride to a concentration of 17% by weight of NaCl. The NaCl-containing solution produced in this way is subsequently used for chloralkali electrolysis in a laboratory electrolysis cell. The electrolysis cell has an anode area of 0.01 m² and is operated at a current density of 4 kA/m², a temperature at the outlet from the cathode side of 88° C., and a temperature at the output from the anode side of 89° C. Commercially coated electrodes having a coating for chloralkali electrolysis from DENORA, Germany are used as electrodes. An ion-exchange membrane N982 WX from Chemours is used for separating anode space and cathode space. The electrolysis voltage is 3.02 V. A sodium chloride-containing solution is pumped at a mass flow of 0.98 kg/h through the anode chamber. The concentration of the solution fed to the anode chamber is 25% by weight of NaCl. A 20% strength by weight NaCl solution can be taken from the anode chamber. 0.121 kg/h of the 17% strength by weight purified NaCl-containing solution and a further 0.0653 kg/h of solid sodium chloride are added to the NaCl solution taken from the anode chamber. The solution is subsequently fed back into the anode chamber.

On the cathode side, a sodium hydroxide solution is pumped in the circuit at a mass flow of 1.107 kg/h. The concentration of the sodium hydroxide solution fed into the cathode side was 30% by weight of NaOH, and the sodium hydroxide solution taken from the cathode side has a concentration of 32% of NaOH, 0.188 kg/h of the 31.9% strength alkali are taken from the volume stream, and the remainder is made up with 0.0664 kg/h of water and recirculated back into the cathode element.

A negative influence of the imitation process water freed of formate by means of the BDD electrode on the performance of the cell cannot be observed.

1.-17. (canceled)

18. A process for the electrochemical purification of chloride-containing aqueous process solutions contaminated with organic chemical compounds using a boron-doped diamond electrode, wherein the purification using a boron-doped diamond electrode is carried out a potential of more than 1.4 V measured against the reversible hydrogen electrode (RHE) and a pH of the process solution of at least pH 10, in the anode zone of an electrolysis cell to a prescribed total content of organic chemical compounds (TOC).

19. The process as claimed in claim 18, wherein the purification is carried out in a plurality of passes of the process solution through the anode zone.

20. The process as claimed in claim 18, wherein the purification is carried out in a plurality of separate anode zones connected in series.

21. The process as claimed in claim 18, wherein the purification is carried out to a total content of organic chemical compounds (TOC) of not more than 500 mg/kg.

22. The process as claimed in claim 18, wherein the process solution contains an organic solvent selected from the group consisting of aliphatic hydrocarbons, aromatic hydrocarbons and halogenated aromatic hydrocarbons.

23. The process as claimed in claim 18, wherein the process solution contains a catalyst residue.

24. The process as claimed in claim 18, wherein the process solution contains monomers or low molecular weight polymers.

25. The process as claimed in claim 18, wherein the process solution comprises cresols, in particular from preproduction for crop protection agents, as organic chemical impurity.

26. The process as claimed in claim 18, wherein the concentration of chloride ions in the process solution at the beginning of the purification is up to 20% by weight.

27. The process as claimed in claim 18, wherein the process solution comprises essentially chloride ions from alkali metal chloride, in particular sodium chloride.

28. The process as claimed in claim 18, wherein the process solution is a process water from the production of polymers, in particular a polymer from the group consisting of polycarbonate, polyurethanes and precursors thereof, in particular of isocyanates, particularly preferably of methylenedi(phenyl isocyanate) (MDI), tolylene diisocyanate (TDI), or from the production of dyes, crop protection agents, pharmaceutical compounds and precursors thereof.

29. The process as claimed in claim 18, wherein the process solution is a process water from the production of epichlorohydrin.

30. The process as claimed in claim 18, wherein the boron-doped diamond electrode is based on a support composed of at least one material selected from the group consisting of: tantalum, silicon and niobium.

31. The process as claimed in claim 18, wherein the boron-doped diamond electrode has a multiple coating comprising finely divided diamond.

32. The process as claimed in claim 30, wherein the multiple coating comprising diamond has a minimum thickness of 10 μm.

33. The process as claimed in claim 18, wherein the purified process water is subsequently subjected to an alkali metal chloride electrolysis.

34. The process as claimed in claim 32, wherein the materials chlorine and sodium hydroxide and optionally hydrogen obtainable from the alkali metal chloride electrolysis located downstream of the electrolytic purification are recirculated independently of one another to the chemical production of polymers, dyes, crop protection agents, pharmaceutical compounds and precursors thereof.
